(19) United States
(12) Patent Application Publication
(10) Pub. No.: US 2003/0207599 A1
(43) Pub. Date: Nov. 6, 2003

(54) Signal extension card socket for aligned wire connector

(75) Inventor: William Chen, Taipei (TW)

Correspondence Address: BACON & THOMAS, PLLC, 625 SLATERS LANE, FOURTH FLOOR, ALEXANDRIA, VA, 22314

(73) Assignee: Q-Mark Technology Corp., Taipei (TW)

(21) Appl. No.: 10/138,432

(22) Filed: May 6, 2002

(51) Int. Cl. H01R 12/00

(52) U.S. Cl. 439/79

(57) ABSTRACT

The present invention is a signal extension card socket for aligned wire connector through which the video signals on the LCD screen of small electronic products, such as GBA, PDA and notebook, can be conveyed and displayed easily on various large TV screens or computer monitors through the embedded signal extension card. The present invention for the signal extension card socket includes the base, the clip plate, the aligned wire and wire leads with a fixing part for one end of the aligned wire to plug in. The electric conducting strip with detailed electric conductors is attached on the base piled up with the clip plate. On the rectangle sides of the base are provided with the raised hook for positioning of the clip plate, ensuring a complete output of the video signals from the LCD screens when connecting to the GBA, PDA and notebooks.

### FIELD OF THE INVENTION

The present invention is related to a connecting media conveying video signals; in other words, this media retrieves required signals from LCD monitors of small electric products, such as GAB, PDA and notebooks, and then decodes, transforms the composed signals and conveys them to various large TV screens and computer monitors.

### BACKGROUND OF THE INVENTION

Considering the prevalent GBA (GAMEBOY ADVANCE) or GBC (GAMEBOY COLOR), portable PDA and notebooks that seeks for light and small designs, LCD monitors equipped on these products are also restricted to light and small designs of these products. However, since the main users of the small GBA are small children and school children, the small size, dark and poor screen quality and lack of backlight function of the LCD screens usually cause harm to the eyesight of the children. Although the main users of PDA and notebooks are adults, their eyes are also hurt after long-term usage.

Moreover, the rapid-development of the GBA nowadays with the assistance of the stereo, light effects and high quality screens, allows children to experience the on the-spot feeling during the game while flavors the games with more amusement and novelty. Nevertheless, the GBA with the LCD screen fails to put the shocking effect into full play, so the game is monotonous and imperfectible. Therefore, the structure and the future development still have room for improvement. As for the businessmen who use PDA and notebooks over a long period of time, the extension function that displays the signals on large monitors at any time will surely contribute to the business.

Because of this, the industry developed a video converter that conveys the screen signals of the GAB through special transformation and display on other high quality screens, so as to achieve the best resolution effect (refer to No. 90214741 of our patent for the practicing pattering of this model). This design not only broke through the restriction of the LCD screen on GBA, but also improved the disadvantages of the monotone, lacking for novelty and insufficient excitement in the game, while avoiding the demerits of damaging children's eyesight. This invention was a pioneering work in the industry. The only blemish for the connecting media needing improvement is that the design conveys signals to different specifications of computer monitors in AV terminals or S output terminals, or the Video Graphic Array VGA. However, whether in AV terminals or VGA, the connector for connecting the output terminals can not connect closely that causes it to come off easily, leading to the dimness and interruption of the screen. This might cause the interruption of the game, or more seriously, damage to the eyesight.

In view of this, the inventor of the present has been seeking for a solution with many years of experience and professional knowledge, and after constant research and trials, has came up with an embedded connecting media that conveys the screen signals of the GBA and displays them on other screens with better displaying quality.

### SUMMARY OF THE INVENTION

The main objective of the present invention is to provide a signal extension card socket for aligned wire connector that consists of an embedded electric conducting plug to connect with the aligned wire, so as to convey the video signals on the LCD screen of small electric products, such as the GAB, PDA and notebooks, and display on the screen of various large video products TV, computer. This design flavors the multi-play games with more amusement, while achieves the benefit of protecting children's eyes.

### BRIEF DESCRIPTION OF THE DRAWINGS

The description of the practicing illustrations and figures are provided for further understanding of the objects, functions and characteristics of the present invention:

FIG. 1 is a three-dimensional decomposition illustration for the present invention.

FIG. 2 is a three-dimensional assemblage illustration for the present invention.

FIG. 3 is a partial magnifying illustration for the present invention.

FIG. 4 is a practicing illustration for the present invention.

### DETAILED DESCRIPTION OF THE INVENTION

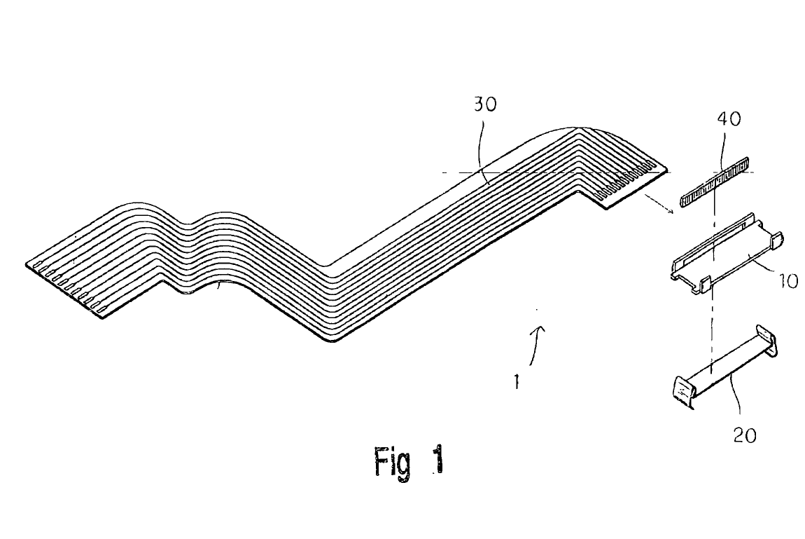

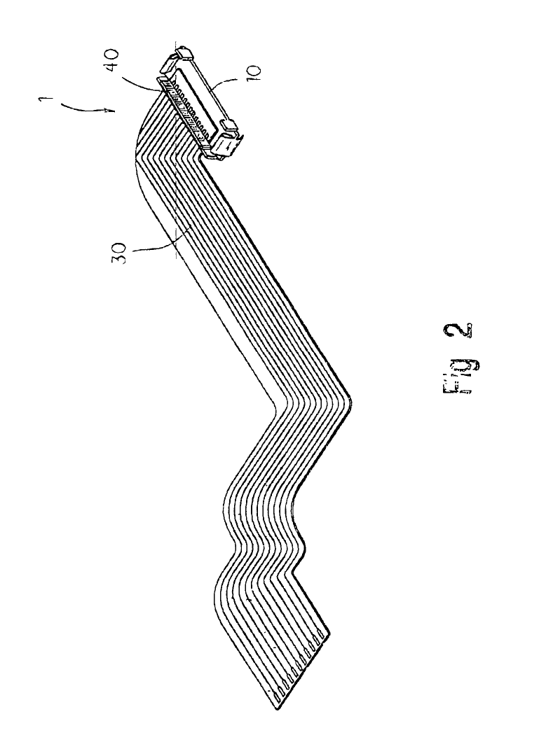

Please refer to FIGS. 1 and 2. The signal extension card socket for the aligned wire connector of the present invention is a connecting media for transforming video signals. With this signal extension card socket 1 to retrieve the required signals from the LCD screen of the small electric products, such as GAB, PDA and notebooks, the decoded, transformed and composed signals are output to various specifications of TV screens and computer monitors. The signal extension card socket for aligned wire connector 1 includes:

The slab-shaped rectangle base 10 in FIG. 1 with the fixing part 11 set with the socket holes 12 on one longer side and the clips 13 on both ends of the other longer side. On both short sides of the base 10 are indented notches 14.

The slab-shaped rectangle clip plate 20 with the protruding hooks 21 bended on both short sides for the clip plate 20 to fix on the base by wedging the hooks 21 onto the notches 14 separately and then adhering them into one.

The aligned wire 30 with the connective head 31 on one end insetting into the stripe socket holes 12 on the fixing part 11 on the longer side of the base 10 and are adhere for fixture.

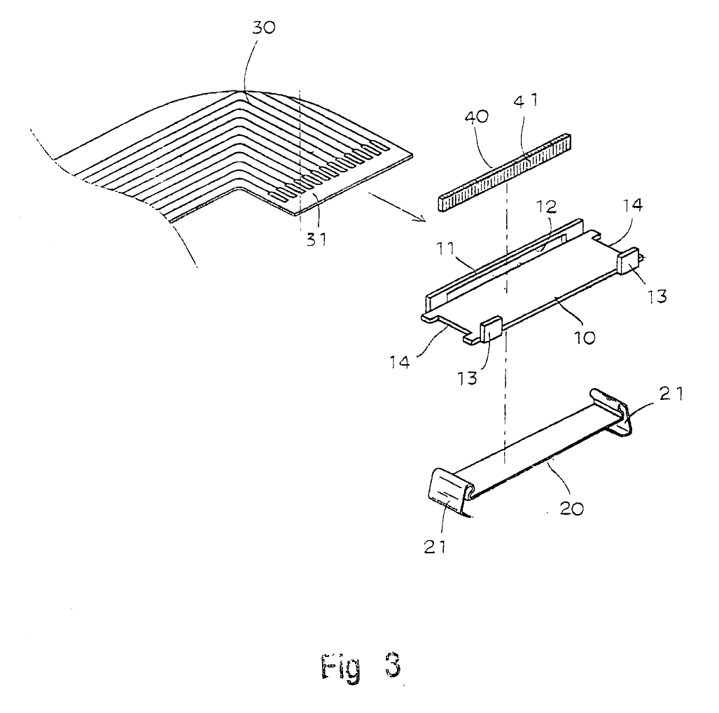

The electric conducting stripe 40 is a soft layering with detailed electric conductors 41 to connect all connecting points on the head of the aligned wire 30, so as to assure the conduction and the transmission of the signals, as shown in FIG. 3.

The above description is the summary of the relative structure and functions for the present invention. The following description is the operation theory and the efficacy achieved:

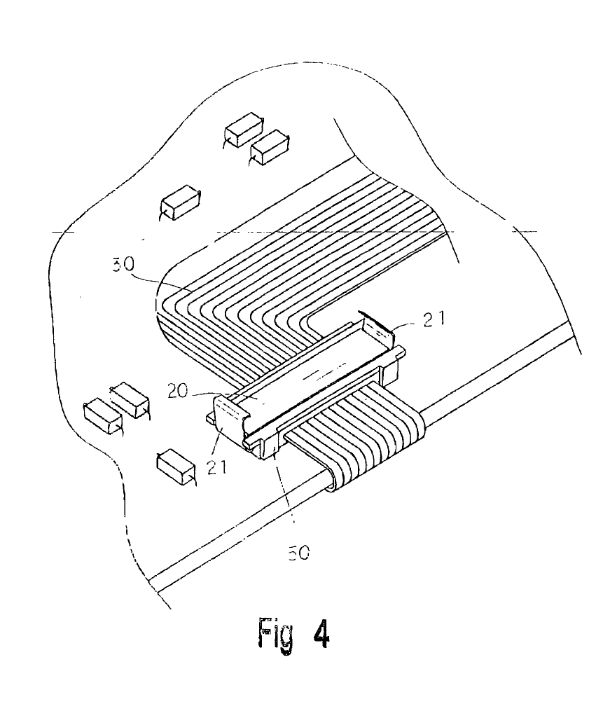

Please refer to FIG. 4 for the practicing pattern as the example of GBA. The signal extension card socket for aligned wire connector 1 connects itself to the aligned wire connecting base 50 of the LCD screen linked to the existing video converting process circuit inside the GAB. Then, with the fixing part 11 and the clips 13 on longer sides of the base 10 and the hooks 21 on short sides of the clip plate 20 to connect closely to the four edges of the connecting base 50, the electric conducting stripe 40 and the connecting base 50 are connected for electric conduction and then for the transmission of the video signals. In this way, the video signals on the LCD screen of the GBA can be successfully transmitted and displayed on various specifications of TV screens or computer monitors. Meanwhile, this design also flavors the games with amusement as well as provides sufficient novelty and beautification and prevents damage to the eyesight.

In summary, the signal extension card socket for aligned wire connector of the present invention not only broke through the technology of the traditional mechanism but also provided more practicability. On account of the lack of relative information released or published, the inventor hereby apply for the patent for the present invention.

What is claimed is:

1. A signal extension card socket for aligned wire connector, comprising:
a base with a fixing part set with stripe socket holes on a longer side and clips on both ends of other long side, and indented notches formed on both short sides of said base;
a clip plate with protruding hooks bended on both short sides for said clip plate to fix on said base by wedging said hooks onto said notches separately and then adhered into one;
an aligned wire with connective heads on both ends, with one end inset into said socket holes; and
an electric conducting stripe being a soft layering with detailed electric conductors on an internal side of said fixing part to connect with a head of said aligned wire; in this way, video signals on LCD screens of small electric products, such as GBA, PDA and notebooks can be easily conveyed and displayed on screens of video products, such as TV and computer in different specifications.
